(19) United States
(12) Patent Application Publication
(10) Pub. No.: US 2004/0267554 A1
(43) Pub. Date: Dec. 30, 2004

(54) Methods and systems for semi-automated job requisition

(76) Inventors: Gregory P. Bowman, Madison, AL (US); Phillip L. Koon, Huntsville, AL (US); James M. Milstead, Madison, AL (US)

Correspondence Address: BLACK LOWE & GRAHAM, PLLC, 701 FIFTH AVENUE, SUITE 4800, SEATTLE, WA, 98104, US

(21) Appl. No.: 10/608,461

(22) Filed: Jun. 27, 2003

(51) Int. Cl. G06F 17/60

(52) U.S. Cl. 705/1; 705/11

(57) ABSTRACT

Methods and systems for semi-automated job requisition are disclosed. In one embodiment, an inline interview including a set of job characteristics for a position to be filled is formed, and a set of employer rankings for the set of job characteristics is assigned. The inline interview is provided to one or more prospective job seekers. A set of job seeker rankings for the set of job characteristics is received from each of the one or more prospective job seekers. Then, a score is generated for each of the one or more prospective job seekers, including comparing the set of employer rankings with the set of job seeker rankings.

### FIELD OF THE INVENTION

The present invention relates to methods and systems for semi-automated job requisition, including, for example, methods and systems for semi-automated scoring, ranking, and evaluation of job seekers.

### BACKGROUND OF THE INVENTION

Hiring managers and personnel organizations involved in the evaluation and selection of job seekers typically utilize processes that involve sorting and ranking of job seekers based on keyword searches of applications and resumes received from interested job seekers. These processes tend to be highly subjective, time-consuming, and error prone. These problems increase in proportion with the size of the organization and the number of hiring managers and personnel organizations involved in the process. Although desirable results have been achieved using the prior art processes, there remains an unmet need for methods and systems for improved job requisition processes that may provide reduced subjectivity, reduced time, and reduced errors in comparison with the conventional evaluation processes.

### SUMMARY OF THE INVENTION

The present invention is directed to methods and systems for semi-automated job requisition. Apparatus and methods in accordance with the present invention may advantageously reduce errors, improve consistency, decrease time and expense, and provide improved matching of job seekers to positions to be filled in comparison with prior art job requisition processes.

In one embodiment, an inline interview including a set of job characteristics for a position to be filled is formed, and a set of employer rankings for the set of job characteristics is assigned. The inline interview is provided to one or more prospective job seekers. A set of job seeker rankings for the set of job characteristics is received from each of the one or more prospective job seekers. Then, a score is generated for each of the one or more prospective job seekers, including comparing the set of employer rankings with the set of job seeker rankings.

### BRIEF DESCRIPTION OF THE DRAWINGS

The preferred and alternative embodiments of the present invention are described in detail below with reference to the following drawings.

FIG. 1 is a schematic overview of a requisition process in accordance with an embodiment of the present invention;

FIG. 2 is a flowchart of an embodiment of a position description creation process of the requisition process of FIG. 1 in accordance with an embodiment of the present invention;

FIG. 3 is a flowchart of an embodiment of a job application process of the requisition process of FIG. 1 in accordance with an embodiment of the present invention;

FIG. 4 is a flowchart of an embodiment of a job seeker selection process of the requisition process of FIG. 1 in accordance with an embodiment of the present invention;

FIG. 5 is a flowchart of a logic flow for preparation of an inline interview of the requisition process of FIG. 1 in accordance with an embodiment of the present invention; and

FIG. 6 is a system for performing an automated evaluation process in accordance with another embodiment of the present invention.

### DETAILED DESCRIPTION OF THE INVENTION

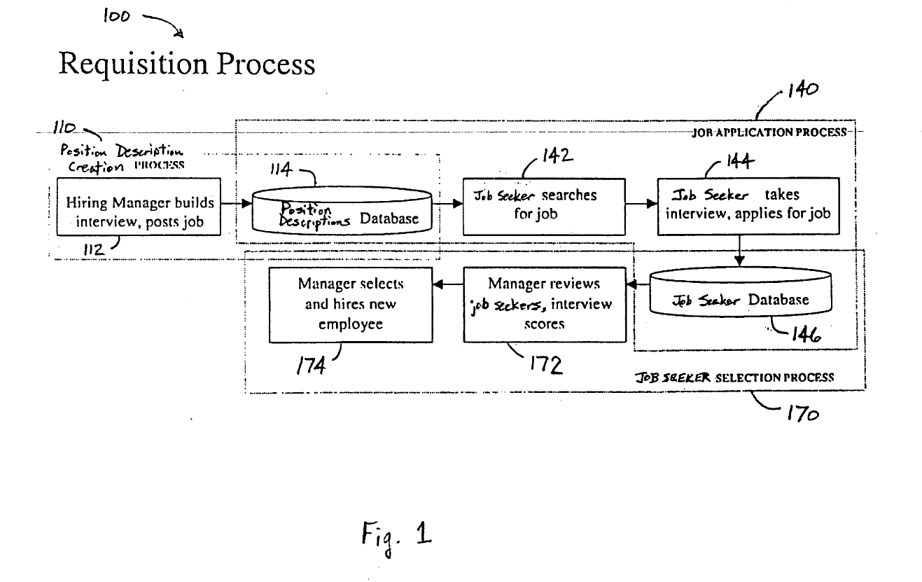

The present invention relates to methods and systems for semi-automated job requisition. Many specific details of certain embodiments of the invention are set forth in the following description and in FIGS. 1-6 to provide a thorough understanding of such embodiments. One skilled in the art, however, will understand that the present invention may have additional embodiments, or that the present invention may be practiced without several of the details described in the following description.

In general, embodiments of methods and systems for semi-automated job requisition in accordance with the present invention may include an employer creating a set of job characteristics for a position by selecting from a predetermined list of applicable skills, tools, and other traits and characteristics. The employer may rank the applicability of each of the job characteristics (or a subset thereof) in accordance with the position being filled. Similarly, when a job seeker applies for the position, the job seeker may be presented with the same predetermined list of skills, tools, and traits (or a subset thereof, such as the set of position-specific job characteristics selected by the employer), and may be required to provide a ranking based on the job seeker's experience, expertise, and desire to perform the presented set of job characteristics. A score may then be derived for the job seeker using an automated computer algorithm. The score may be derived based on various criteria, including the similarities (and differences) between the employer's ranking and the job seeker's ranking of the set of job characteristics. Also, the score may be any type of method of scoring, including, for example, a numeric score, a visual graphic (e.g. a two dimensional target matrix with closer fit nearer the middle of a target), an alphanumeric score, or any other suitable score. A plurality of job seekers may then be ranked based on their scores, and the employer may make decisions regarding interviewing and hiring accordingly.

FIG. 1 is a schematic overview of a requisition process 100 for evaluating a job seeker for a position to be filled in accordance with an embodiment of the present invention. In this embodiment, the requisition process 100 includes a position description creation process 110, a job application process 140, and a job seeker selection process 170. The interactions between the position description creation process 110, the job application process 140, and the job seeker selection process 170 are depicted in FIG. 1 as overlapping areas between the various processes.

In this embodiment, the requisition process 100 includes an employer (e.g. a manager or other personnel) creating a set of job characteristics for a position to be filled at a block 112 as part of the position description creation process 110. A position description (or notice) regarding the position to be filled may also be generated and posted at the block 112, and may be stored or otherwise added to a position descriptions database at a block 114. As further shown in FIG. 1, the requisition process 100 may further include a job seeker searching for a job at a block 142 as part of the job application process 140, during which the job seeker may retrieve and utilize the information contained in the position descriptions database (block 114). When the job seeker locates a position description of interest, the job seeker may take an inline interview and apply for the position at a block 144. In one aspect, the inline interview may be conducted by having the job seeker providing input into a computer software routine via an interactive question and answer process. During the inline interview, the job seeker's inputs may be evaluated, scored, and saved as application information, as described more fully below. The job seeker's application information may then be stored in a job seeker database at a block 146.

With continued reference to FIG. 1, as part of the job seeker selection process 170, the employer may examine the application information for one or more job seekers at a block 172. Finally, the employer may select and hire one of the job seekers for the position at a block 174.

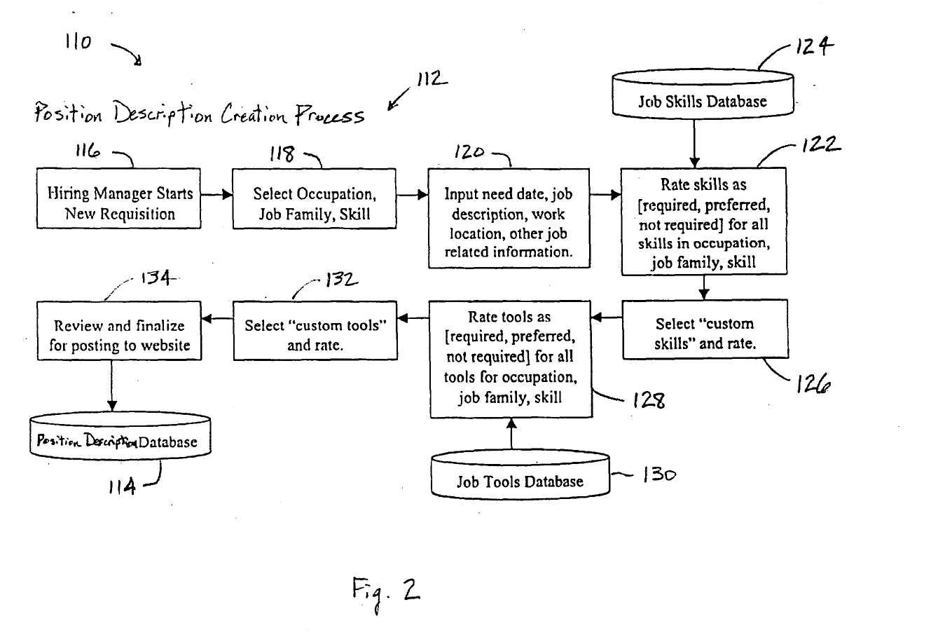

FIG. 2 is a flowchart of an embodiment of the position description creation process 110 of the requisition process 100 of FIG. 1. In this embodiment, the task of creating the set of job characteristics for the position to be filled (block 112) includes the employer starting the position description creation process 110 at a block 116. Next, the employer specifies one or more top-level parameters that categorize the position to be filled at a block 118. The top-level parameters may include, for example, an occupation parameter, a job family parameter, a skill parameter, or any other desired top-level parameter. The employer may then specify one or more intermediate-level parameters involving the position to be filled at a block 120. The intermediate-level parameters may be somewhat more specific to the particular position to be filled than the top-level parameters, and may include, for example, a need date parameter, a job description parameter, a work location parameter, or any other suitable intermediate-level parameters.

As further shown in FIG. 2, the position description creation process 110 further includes defining and ranking (or rating) of one or more job skills involved in the position to be filled at a block 122. This may include accessing a predetermined set of job skills from a job skills database 124, and selecting the job skills from the job skills database 124. The predetermined set of job skills may be an omnibus set of all possible job skills, or alternately, may be a more narrowly tailored set of job skills based on one or more of the top-level and intermediate-level parameters selected by the employer at blocks 118 and 120. In one embodiment, the ranking of the job skills involves assigning a quantitative factor (e.g. a numeric value, a percentage, a weighting factor, etc.) to each of the job skills, and in an alternate embodiment, the ranking involves assigning a qualitative factor (e.g. required, preferred, not required, high, medium, low, important, unimportant, etc.) to each of the job skills.

The position description creation process 110 may further include selecting and ranking one or more custom skills that are applicable to the position to be filled at a block 126. Typically, the custom skills may be highly specific to the particular position to be filled. Next, a ranking of one or more tools that may be involved in the performance of the position to be filled may be performed at a block 128. As shown in FIG. 2, the tools may be selected from a predetermined database of job tools 130. Again, the ranking may involve qualitative or quantitative factors (or both). The tools that may be involved in the ranking at block 128 may be any conceivable type of tool, including software tools (e.g. word processors, spreadsheets, CAD software, numerical simulation software, etc.), manufacturing tools (e.g. riveters, welders, drills, EDM machines, etc.), equipment (e.g. forklifts, trucks, aircraft, etc), or any other type of tool. In one aspect, the tools that are selected and ranked at the block 128 are selected from the job tools databases 130 to promote uniformity and consistency in the definition of the position to be filled across an employer's potentially numerous different facilities and hiring personnel.

With continued reference to FIG. 2, the job selection process 110 may further include a specification and ranking of custom tools that are applicable to the position at a block 132. Like the custom skills described above, the custom tools selected and ranked at block 132 may be highly specific to the particular position to be filled. Again, the custom tools may be any conceivable type of tool. At a block 134, the employer may review, revise, and finalize the previously described selections, rankings, and other input regarding the position to be filled, and then may submit a position description for the position to the position descriptions database 114.

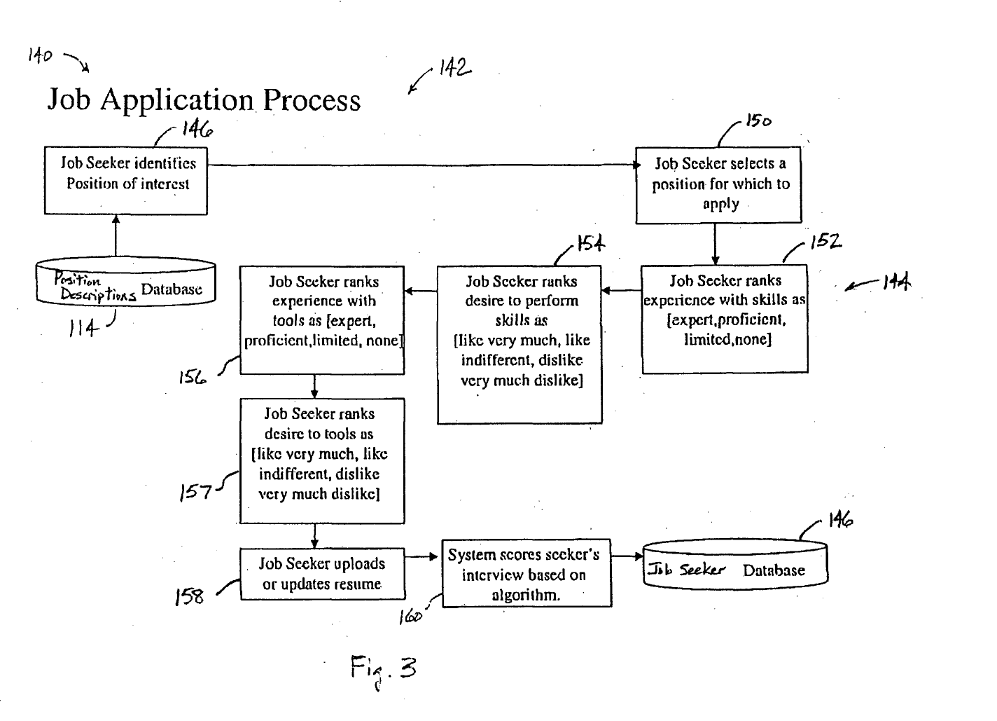

FIG. 3 is a flowchart of an embodiment of the job application process 140 of the requisition process 100 of FIG. 1. In this embodiment, the activity of the job seeker searching for a job (block 142 of FIG. 1) within the position descriptions database 114 includes a job seeker identifying a position of interest in a block 146, such as, for example, by viewing and selecting from a list of position descriptions from the position descriptions database 114 that at least partially satisfy the job seeker's search criteria, or by using a search engine, or by being alerted to a position by a recruiter, or through any other suitable means. The job seeker may then select a position for which to apply at a block 150.

As further shown in FIG. 3, in this embodiment, the activity of the job seeker taking the inline interview and applying for the job (block 144 of FIG. 1) includes the job seeker ranking one or more job characteristics of the particular job at a block 152. For example, the job seeker may rank their job experience with the skills established by the employer. Similar to the rankings described above, the job seeker's ranking may involve qualitative ranking factors (e.g. expert, proficient, limited, etc.) or quantitative factors, or both. Next, at a block 154, the job seeker may rank their desire to perform the various job skills defined by the employer (e.g. like very much, like, indifferent, dislike, etc.). The job seeker may then rank their experience with the tools applicable to the position at a block 156. Similarly, at a block 157, the job seeker may rank their desire to work with the tools applicable to the position. Then, the job seeker may finish the inline interview by uploading their resume (or updating their resume if previously provided) at a block 158. Next, the job seeker's inputs into the inline interview may be scored based on a customized scoring algorithm at a block 160, as described more fully below. The job seeker's relevant application information may then be stored in the job seeker database 146, completing the job application process 140.

It will be appreciated that an extensive variety of computer algorithms may be conceived to perform the scoring of the job seeker's inputs into the inline interview occurring at the block 160 of FIG. 3. In one representative embodiment, for example, a scoring algorithm may be developed in accordance with the following Equation (1):

Job Seeker Score=a0(number of required skills met)+a1(number of required skills exceeded)+a2(number of custom skills met)+a3(number of custom skills exceeded)+a4(number of extra skills)+a5(average desire to perform required skills)+a6(average desire to perform custom skills)+a7(average desire to perform extra skills)+a8(number of required tools met)+a9(number of required tools exceeded)+a10(number of custom tools met)+a11(number of custom tools exceeded)+a12(number of extra tools) (1)

where a0 . . . an are weighting constants that may be assigned a desired value.

In one particular embodiment, for example, the weighting constants a0 . . . an may be assigned values such that [a2˜a10], [a0˜a8], [a3˜a11], [a1˜a9], [a5˜a6], [a4˜a12] (where the symbol ˜ means “approximately equal to”). In another representative embodiment, [a2˜a10]>[a0˜a8]>[a3˜a11]>[a1˜a9]>[a5˜a6]>[a4˜a12]>a7, which is to say, ranking of custom skills and tools may be given a higher weight than the regular requirements, which, in turn, may be given a higher ranking than extraneous skills or tools. Furthermore, the job seeker's desire to perform the specified job activities may be assigned a higher weighting than experience or capability in excess of what is required. The weighting constants a0 . . . an may be adjusted as desired, including, for example, in response to feedback from managers and other employer personnel on the quality of job seekers relative to their scores. Of course, a wide variety of alternate embodiments of Equation (1) may be conceived. In one particular embodiment, for example, separate weighting factors may be assigned to each employer ranking and each job seeker ranking individually (rather than applying a single weighting factor to a difference between an employer ranking and a corresponding job seeker ranking, as shown in Equation (1) above). Alternately, in still further embodiments, the values of one or more of the weighting factors may be set to zero, effectively eliminating those factors (and corresponding rankings) from consideration.

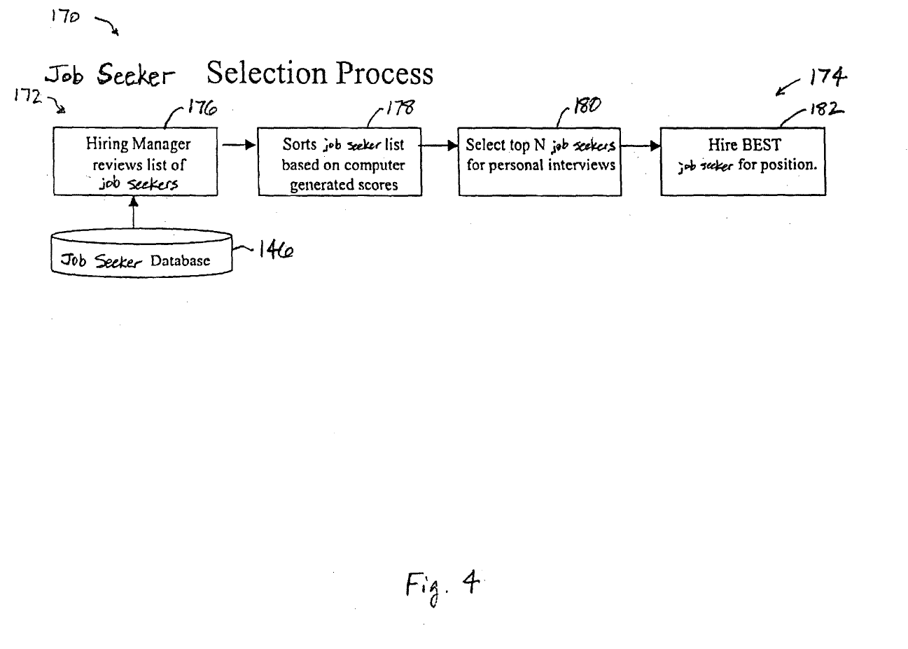

FIG. 4 is a flowchart of an embodiment of the job seeker selection process 170 of the requisition process 100 of FIG. 1. In this embodiment, the activity of the employer reviewing job seekers and their respective interview scores (block 172 of FIG. 1) includes the employer reviewing a list of all job seekers at a block 176, and sorting the list of job seekers based on their scores from the inline interview process at a block 178. Furthermore, the activity of the employer selecting and hiring one of the job seekers for the position (block 174 of FIG. 1) includes selecting a subset of N job seekers for personal interviews (and conducting one or more personal interviews with some or all of the selected job seekers) at a block 180. The employer may then hire one (or more) of the job seekers at a block 182. Preferably, of course, the job seeker hired by the employer is the best job seeker for the position to be filled.

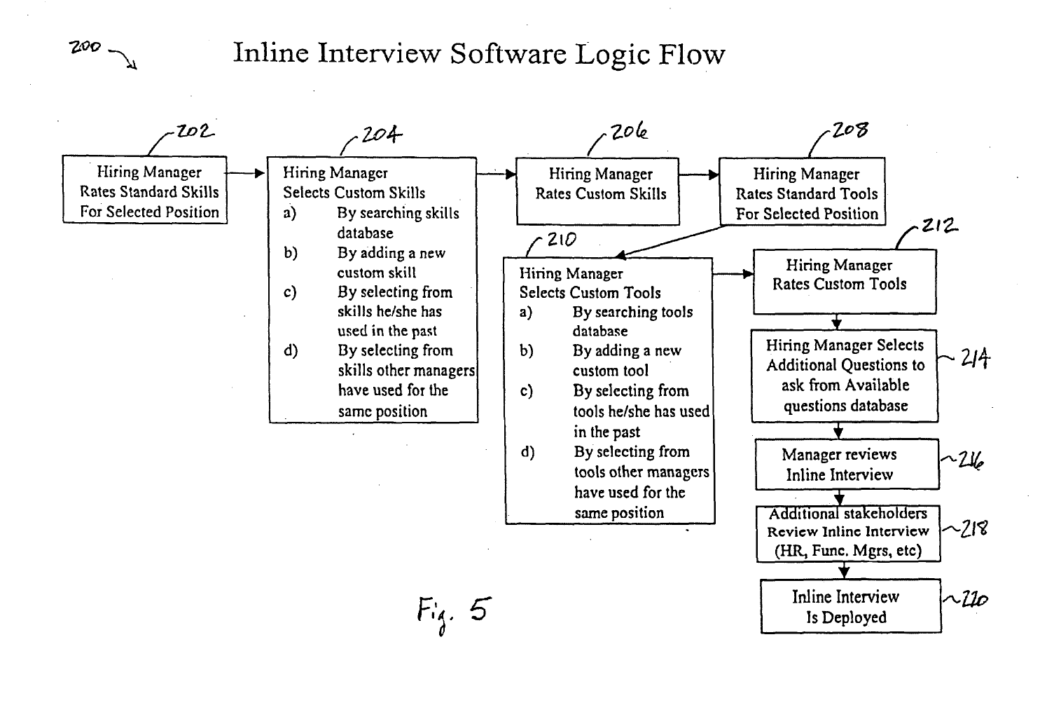

FIG. 5 is a flowchart of a logic flow 200 for preparation of an inline interview in accordance with an embodiment of the present invention. The logic flow 200 may, for example, be part of the activity of the employer building the inline interview in the position description creation process 110 of the requisition process 100 of FIG. 1. In this embodiment, the logic flow 200 includes a hiring manager (or other suitable personnel) ranking a set of standard skills for a position to be filled at a block 202. The hiring manager may then designate a set of custom skills applicable to the position at a block 204. The custom skills may be designated in any suitable manner, including, for example, by searching and selecting skills from a predetermined database of custom skills, by adding a new custom skill, by selecting from previously used or defined skills, by selecting from custom skills previously defined by other hiring managers or personnel, or any other desired method. Next, at a block 206, the hiring manager may assign rankings to the custom skills.

As further shown in FIG. 5, the hiring manager may rank a set of standard tools applicable to the position at a block 208. The hiring manager may then select a set of custom tools at a block 210, and may then rank the selected custom tools at a block 212. Next, the hiring manager may select additional questions to include in the inline interview from a database of available questions at a block 214. At a block 216, the hiring manager may then review (and revise if necessary) the inline interview created in blocks 202 through 214. The logic flow 200 may further include a review of the inline interview by one or more additional stakeholders (e.g. human resources personnel, other managers, customers, etc.) at a block 218 prior to deployment of the inline interview at a block 220.

It will be appreciated that a variety of different embodiments of methods in accordance with the teachings of the present invention may be conceived, and that the invention is not limited to the particular embodiment described above and shown in FIGS. 1-4. For example, in alternate embodiments, the scoring of the job seeker's inputs to the inline interview (block 160 of FIG. 3) may be performed during the job seeker selection process 170 rather than during the job application process 140. Similarly, the ranking of the job characteristics by the employer (blocks 122, 128, 132 of FIG. 1) may be conducted during the job seeker selection process 170 rather than during the position description creation process 110. Additionally, in alternate embodiments, several of the activities described above may be eliminated. Some of the activities that may be eliminated include, for example, the review by additional stakeholders of the inline interview (block 218 of FIG. 5), the selection and ranking of custom tools (block 132 of FIG. 2), and the selection and ranking of custom skills (block 126 of FIG. 2) by the employer. Furthermore, one or more additional activities may be added to the methods described above, such as the employer performing a validation of the results of the inline interview by, for example, counting occurrences of key works and phrases from the tools and skills descriptions in the job seeker's resume. Clearly, a variety of modifications to the exemplary requisition process 100 described above and shown in FIGS. 1-4 may be conceived without departing from the spirit and scope of the present invention.

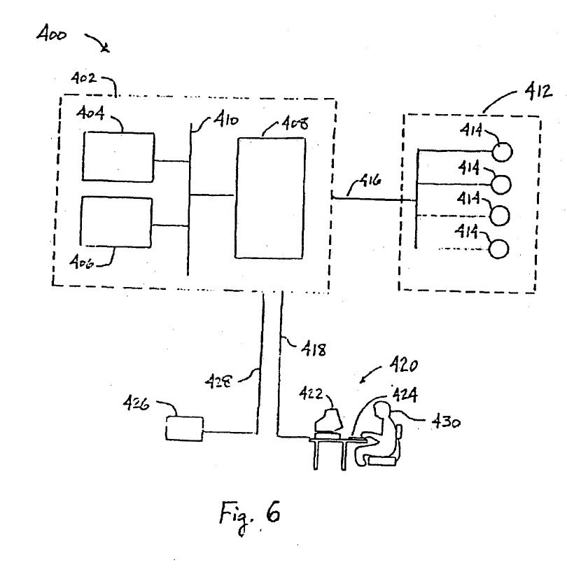

FIG. 6 is a system 400 for performing an automated job seeker evaluation process in accordance with an embodiment of the present invention. In this embodiment, the system 400 includes a computer 402, a job seeker input component 412, and an employer input component 420. Unless otherwise specified below, the components of the system 400 are of generally-known construction, and will not be described in detail. For the sake of brevity, only significant details and aspects of the system 400 will be described.

As shown in FIG. 6, in this embodiment, the computer 402 includes a central processing unit (CPU) 404 and a memory component 406. The memory component 406 may include one or more memory modules, such as Random Access Memory (RAM) modules, Read Only Memory (ROM) modules, Dynamic Random Access Memory (DRAM) modules, and any other suitable memory modules. The computer 402 also includes an input/output (I/O) component 408 that may include a variety of known I/O devices, including network connections, video and graphics cards, disk drives or other computer-readable media drives, displays, or any other suitable I/O modules. A data bus 410 operatively couples the CPU 404, memory component 406, and the I/O component 408.

The job seeker input component 412 is operatively coupled to the computer 402 by a first communication link 416. In this embodiment, the job seeker input component 412 includes a plurality of remote input devices 414. In one particular embodiment, the remote input devices 414 are remotely positioned personal computers. Alternately, the remote input devices 414 may be telephones, keyboards, or any other suitable input devices. Similarly, the first communication link 416 may be any suitable communication link, including, for example, a global computer communication network (i.e. internet), an intranet, a telephone line, a wireless link, or any other desired communication link.

As further shown in FIG. 6, the employer input component 420 may include a monitor 422 and a command input device 424 (e.g. a keyboard, an audio-visual input device, etc.). A second communication link 418 operatively couples the employer input component 420 to the computer 402. The system 400 also includes an auxiliary device 426 coupled to the computer 402 by a third communication link 428. The auxiliary device 426 may include a printer, a compact disk (CD) burner, a storage device, a communication port, or any other desired auxiliary device.

In one aspect, a machine-readable medium may be used to store a set of machine-readable instructions (e.g. a computer program) into the computer 402, wherein the machine-readable instructions embody a method of filling a job position in accordance with an embodiment of the present invention. The machine-readable medium may be any type of medium which can store data that is readable by the computer 402, including, for example, a floppy disk, CD ROM, optical storage disk, magnetic tape, flash memory card, digital video disk, RAM, ROM, or any other suitable storage medium. The machine-readable medium, or the instructions stored thereon, may be temporarily or permanently installed in any desired component of the system 400, including, for example, the I/O component 408, the memory component 406, and the auxiliary device 426. Alternately, the machine-readable instructions may be implemented directly into one or more components of the computer 402, without the assistance of the machine-readable medium.

In operation, the computer 402 may be configured to perform one or more of the aspects of the method of filling a job position described above. For example, a hiring manager (or other suitable personnel) 430 may provide one or more inputs via the command input device 424 to create an inline interview and a position description as set forth above. The position description may then be stored in the memory component 406 of the computer 402 (or within the auxiliary device 426). One or more job seekers may search the available position descriptions, and may provide take inline interviews by means of the job seeker input devices 414. The computer 402 may be configured to receive the employer's inputs via the employer input component 420, and the job seekers' inputs via the job seeker input component 412, and to perform a method of evaluating a job seeker in accordance with the teachings of the present invention. For example, a set of software instructions may be stored in the computer 402 (e.g. in the memory component 406) that causes the inputs from the employer input and job seeker input components, 420, 412 to be read into the memory component 406 and processed using the CPU 404 in accordance with one or more methods described above with respect to FIGS. 1-5. Alternately, one or more aspects of the various processes described above may be implemented in the computer 402 using any suitable programmable or semi-programmable hardware components (e.g EPROM components).

Results of the computational analyses performed by the computer 402 on the inputs provided by the employer input and job seeker input components, 420, 412 may be transmitted via the data bus 410 to the I/O component 408. In alternate embodiments, the results may be transmitted to one or more of the employer input component 420, the job seeker input component 412, and the auxiliary device 426. The hiring manager 430 may view and sort the results of the computational analyses on the control monitor 422, and may take appropriate action, including selecting a set of job seekers for personal interviews, selecting a job seeker to be hired for the position, or revising the inline interview inputs to conduct additional inline interviews, and continuing or repeating the one or more aspects of the requisition process as desired.

Embodiments of methods and systems for semi-automated job requisition in accordance with the present invention may provide significant advantages over the prior art. For example, because the inline interview may be tailored by the employer to include custom requirements (e.g. skills, tools, etc.) that are specific to the position to be filled, and because job seekers may view and respond to the custom requirements contained in the inline interview, the probability that an appropriate job seeker may be located for the position may be increased, and mismatches between job seekers and job requirements may be reduced.

Methods and systems in accordance with the present invention may provide an improved common point of reference for employers and job seekers alike. For example, because the same questions may be presented to all job seekers for a given position via the inline interview, and because job seekers are responding to the same questions, the uniformity and consistency of the process of evaluating job seekers may be improved. Since both job seekers and employers are dealing with a more consistent set of parameters in the job requisition process, more accurate comparisons between job seekers may be performed.

Furthermore, embodiments of the present invention may improve the understanding of job seekers (and employers) of the requirements of a given position prior to the hiring of a job seeker. Because the process for creating the inline interview provides for input from one or more stakeholders, the job characteristics for the position may be more well-defined and agreed upon, thereby improving the probability of locating an appropriate job seeker. In addition, because the requisition process is improved and the job seeker is better matched for the requirements of the position, the retention of the job seeker may be improved, thereby reducing the expenses associated with undesired attrition for the employer.

In addition, embodiments of methods and systems in accordance with the present invention may provide reduced subjectivity in the job seeker evaluation and selection process. Because job seeker inputs to the inline interview may be scored and ranked by appropriate computer software that reads inputs from the job seeker and the employer, and performs comparisons between job characteristics and job seeker desires in a more objective manner, the ranking and selection of job seekers may be improved in comparison with relatively more subjective prior art processes. Since job seeker inputs may be received in an online fashion at any time or from any place without participation of the employer, the expense associated with the initial stages of evaluation and ranking of multiple job seekers may be reduced, and the inputs of a greater number of job seekers may be more successfully and practically performed. Overall, embodiments of methods and systems in accordance with the present invention may reduce errors, improve consistency, decrease time and expense, and provide improved matching of job seekers to positions to be filled in comparison with prior art job requisition processes.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method for job requisition, comprising:
forming an inline interview including a set of job characteristics for a position to be filled;
assigning a set of employer rankings for the set of job characteristics;
providing the inline interview to one or more prospective job seekers;
receiving a set of job seeker rankings for the set of job characteristics from each of the one or more prospective job seekers; and
generating a score for each of the one or more prospective job seekers, including comparing the set of employer rankings with the set of job seeker rankings.

2. The method of claim 1, wherein forming an inline interview includes defining one or more job skills associated with the position.

3. The method of claim 2, wherein defining one or more job skills associated with the position includes accessing a predetermined set of job skills from a job skills database.

4. The method of claim 3, wherein accessing a predetermined set of job skills from a job skills database includes accessing a predetermined set of job skills from an omnibus set of all possible job skills.

5. The method of claim 3, wherein accessing a predetermined set of job skills from a job skills database includes accessing a tailored set of job skills according to one or more parameters associated with the position.

6. The method of claim 2, wherein defining one or more job skills associated with the position includes selecting a standard job skill from a predetermined job skills database, and forming a custom job skill specifically applicable to the position to be filled.

7. The method of claim 1, wherein forming an inline interview includes defining one or more job tools associated with the position.

8. The method of claim 7, wherein defining one or more job tools associated with the position includes at least one of:
selecting one or more standard tools from a predetermined set of job tools; and
defining one or more custom tools specifically applicable to the position to be filled.

9. The method of claim 1, wherein assigning a set of employer rankings for the set of job characteristics includes assigning at least one of a quantitative factor and a qualitative factor to each of the set of job characteristics.

10. The method of claim 1, wherein providing the inline interview to one or more prospective job seekers includes posting the inline interview on a website of a global computer communication network.

11. The method of claim 1, wherein receiving a set of job seeker rankings for the set of job characteristics includes receiving at least one of a quantitative factor and a qualitative factor to each of the set of job characteristics.

12. The method of claim 1, wherein generating a score for each of the one or more prospective job seekers includes computing a score using a plurality of computer-readable instructions embodied in a software routine.

13. The method of claim 1, wherein the set of employer rankings includes a plurality of first quantitative rankings and the set of job seeker rankings includes a plurality of second quantitative rankings, and where generating a score for each of the one or more prospective job seekers includes calculating a score based on the first and second quantitative rankings.

14. The method of claim 1, wherein the set of employer rankings includes a plurality of first qualitative rankings and the set of job seeker rankings includes a plurality of second-qualitative rankings, and where generating a score for each of the one or more prospective job seekers includes calculating a score based on the first and second qualitative rankings.

15. The method of claim 1, wherein generating a score for each of the one or more prospective job seekers includes, for each of the set of job characteristics, multiplying a difference between a particular employer's ranking and a particular job seeker's ranking by a weighting value to produce a job characteristic product, and summing over all the job characteristic products.

16. The method of claim 15, wherein generating a score for each of the one or more prospective job seekers includes multiplying an a0 by a number of required skills met to provide a first product, multiplying an a1 by a number of required skills exceeded to provide a second product, multiplying an a2 by a number of custom skills met to provide a third product, multiplying an a3 by a number of custom skills exceeded to provide a fourth product, multiplying an a4 by a number of extra skills to provide a fifth product, multiplying an a5 by an average desire to perform required skills to provide a sixth product, multiplying an a6 by an average desire to perform custom skills to provide a seventh product, multiplying an a7 by an average desire to perform extra skills to provide an eighth product, multiplying an a8 by a number of required tools met to provide a ninth product, multiplying an a9 by a number of required tools exceeded to provide a tenth product, multiplying an a10 by a number of custom tools met to provide an eleventh product, multiplying an a11 by a number of custom tools exceeded to provide a twelfth product, and multiplying an a12 by a number of extra tools to provide a thirteenth product.

17. The method of claim 16, wherein [a2˜a10], [a0˜a8], [a3˜a11], [a1˜a9], [a5˜a6], and [a4˜a12].

18. The method of claim 16, wherein [a2˜a10]>[a0˜a8]>[a3˜a11]>[a1˜a9]>[a5˜a6]>[a4˜a12]>a7.

19. The method of claim 16, where the weighting values are assigned so that a ranking of at least one of custom skills and custom tools is at a higher weight than a ranking of regular skills and regular tools.

20. The method of claim 16, where the weighting values are assigned so that a ranking of the job seeker's desire to perform a specified job activity is at a higher weight than a ranking of at least one of an experience and a capability in excess of a required level.

21. A computer program product adapted to perform a job requisition, the computer program product comprising:
a first computer program portion adapted to perform a position description creation process, the position description creation process including forming an inline interview having a set of job characteristics for a position to be filled, assigning a set of employer rankings for the set of job characteristics, and providing the inline interview to one or more prospective job seekers;
a second computer program portion adapted to perform a job application process, the job application process including receiving a set of job seeker rankings for the set of job characteristics from each of the one or more prospective job seekers; and
a third computer program portion adapted to perform a job seeker selection process, the job seeker selection process including generating a score for each of the one or more prospective job seekers by comparing the set of employer rankings with the set of job seeker rankings.

22. The computer program product of claim 21, wherein the first computer program portion is further adapted to define one or more job skills associated with the position.

23. The computer program product of claim 22, wherein the first computer program portion is further adapted to access a predetermined set of job skills from a job skills database.

24. The computer program product of claim 22, wherein the first computer program portion is further adapted to access a predetermined set of job skills from an omnibus set of all possible job skills.

25. The computer program product of claim 22, wherein the first computer program portion is further adapted to access a tailored set of job skills according to one or more parameters associated with the position.

26. The computer program product of claim 22, wherein the first computer program portion is further adapted to select a standard job skill from a predetermined job skills database, and form a custom job skill specifically applicable to the position to be filled.

27. The computer program product of claim 21, wherein the first computer program portion is further adapted to define one or more job tools associated with the position.

28. The computer program product of claim 27, wherein the first computer program portion is further adapted to define one or more job tools associated with the position by at least one of:
selecting one or more standard tools from a predetermined set of job tools; and
defining one or more custom tools specifically applicable to the position to be filled.

29. The computer program product of claim 21, wherein the first computer program portion is further adapted to assign at least one of a quantitative factor and a qualitative factor to each of the set of job characteristics.

30. The computer program product of claim 21, wherein the first computer program portion is further adapted to post the inline interview on a website of a global computer communication network.

31. The computer program product of claim 21, wherein the second computer program portion is further adapted to receive a set of job seeker rankings for the set of job characteristics including at least one of a quantitative factor and a qualitative factor for each of the set of job characteristics.

32. The computer program product of claim 21, wherein the set of employer rankings includes a plurality of first quantitative rankings and the set of job seeker rankings includes a plurality of second quantitative rankings, and wherein the third computer program portion is further adapted to calculate a score by comparing the first and second quantitative rankings.

33. The computer program product of claim 21, wherein the set of employer rankings includes a plurality of first qualitative rankings and the set of job seeker rankings includes a plurality of second qualitative rankings, and wherein the third computer program portion is further adapted to calculate a score by comparing the first and second qualitative rankings.

34. The computer program product of claim 21, wherein the third computer program portion is further adapted to calculate a score for each of the one or more prospective job seekers, including, for each of the set of job characteristics, multiplying a difference between the employer's ranking and the job seeker ranking by a weighting value to produce a job characteristic product, and summing over all the job characteristic products.

35. The computer program product of claim 34, wherein calculating the score for each of the one or more prospective job seekers includes assigning weighting values so that a ranking of at least one of custom skills and custom tools is at a higher weight than a ranking of regular skills and regular tools.

36. The computer program product of claim 34, wherein calculating the score for each of the one or more prospective job seekers includes assigning weighting values so that a ranking of the job seeker's desire to perform a specified job activity is at a higher weight than a ranking of at least one of an experience and a capability in excess of a required level.

37. A system for conducting a job requisition, comprising:
an employer input component;
a job seeker input component; and
a computer operatively coupled to the employer input component and the job seeker input component, the computer including:
an input/output device coupled to receive a set of employer rankings of a set of job characteristics from the employer input component, and a set of job seeker rankings of the set of job characteristics from the job seeker input component; and
a processor adapted to receive the sets of job seeker and employer rankings and to analyze the sets of job seeker and employer rankings, the processor including:
a first computer program portion adapted to perform a position description creation process, the position description creation process including forming an inline interview presenting the set of job characteristics for the position to be filled, assigning a set of employer rankings for the set of job characteristics, and providing the inline interview to one or more prospective job seekers;
a second computer program portion adapted to perform a job application process, the job application process including receiving a set of job seeker rankings for the set of job characteristics from each of the one or more prospective job seekers; and
a third computer program portion adapted to perform a job seeker selection process, the job seeker selection process including generating a score for each of the one or more prospective job seekers by comparing the set of employer rankings with the set of job seeker rankings.

38. The system of claim 37, wherein the input/output devise is adapted to receive at least one of the set of job seeker rankings and the set of employer rankings via a computer communication network.

39. The system of claim 37, wherein the first computer program portion is further adapted to receive the set of employer rankings for the set of job characteristics including at least one of a quantitative factor and a qualitative factor for each of the set of job characteristics.

40. The system of claim 37, wherein the second computer program portion is further adapted to receive the set of job seeker rankings for the set of job characteristics including at least one of a quantitative factor and a qualitative factor for each of the set of job characteristics.

41. The system of claim 37, wherein the third computer program portion is further adapted to calculate a score for each of the one or more prospective job seekers, including, for each of the set of job characteristics, multiplying a difference between the employer's ranking and the job seeker ranking by a weighting value to produce a job characteristic product, and summing over all the job characteristic products.

42. The system of claim 41, wherein calculating the score for each of the one or more prospective job seekers includes assigning weighting values so that a ranking of at least one of custom skills and custom tools is at a higher weight than a ranking of regular skills and regular tools.

43. The system of claim 41, wherein calculating the score for each of the one or more prospective job seekers includes assigning weighting values so that a ranking of the job seeker's desire to perform a specified job activity is at a higher weight than a ranking of at least one of an experience and a capability in excess of a required level.
